(19) United States
(12) Patent Application Publication
(10) Pub. No.: US 2005/0255277 A1
(43) Pub. Date: Nov. 17, 2005

(54) Perforated sheet material

(76) Inventor: John Syron, Grand Blanc, MI (US)

Correspondence Address: Ronald W. Citkowski;Gifford, Krass, Groh, Sprinkle,, Anderson & Citkowski, P.C., P.O. Box 7021, Troy, MI, 48007-7021, US

(21) Appl. No.: 11/126,936

(22) Filed: May 11, 2005

Related U.S. Application Data
(60) Provisional application No. 60/570,252, filed on May 12, 2004.

(51) Int. Cl. G09F 3/00

(52) U.S. Cl. 428/43; 428/343

(57) ABSTRACT

A material for masking an article which is to be painted includes a sheet of paint impervious masking material and a layer of adhesive. The layer of adhesive is disposed upon at least a portion of a side of the sheet of masking material. A pattern of perforations is defined through the sheet of masking material. A cut passes through the sheet of masking material and intersects the pattern of perforations.

### REFERENCES TO RELATED

This application also claims priority from U.S. Provisional Patent Application Ser. No. 60/570,252, filed May 12, 2004, the content of which is incorporated herein by reference in its entirety.

### FIELD OF THE INVENTION

This invention relates generally to sheet material. More specifically, the invention relates to sheet material having perforations which allow a portion of said sheet material to be torn away from the remainder of said sheet material. Most specifically, the invention relates to a body of perforated sheet material having specifically sized and located cuts which facilitate tearing of the sheet material along said perforations.

### BACKGROUND OF THE INVENTION

Many types of sheet material include a pattern of perforations which facilitates tearing the sheet material into smaller size portions for particular uses. For example, perforations are included in articles as diverse as paper toweling and similar roll materials, flat stock such as stamps, coupons and the like, as well as specialty items such as pre-patterned masking materials for use in the painting of articles such as motor vehicles and the like. Often, users find it difficult to cleanly separate the sheet material along its predefined perforated pattern. In many instances, particularly when a user is acting in haste, the article will not tear cleanly along the perforations. In most instances, the failure to form a clean tear will generally commence at an edge of the perforated material. In some cases, this failure to form a clean tear is only of minor inconvenience; however, in particular applications such as paint masking, such failures constitute a significant loss of worker time and/or materials.

As will be explained hereinbelow, the present invention provides a perforated sheet material which tears cleanly thereby avoiding problems occasioned by prior art materials.

### SUMMARY OF THE INVENTION

According to one aspect of the invention, a body of sheet material is provided having a pattern of perforations defined therein. The perforations are disposed and operational so as to permit a selected portion of the body of sheet material to be separated from the remainder of the body, wherein the improvement includes at least one cut which passes through the thickness of the body of material. The at least one cut commences at an edge of the body and intersects the pattern of perforations.

According to another aspect of the invention, a material is provided for masking an article which is to be painted. The material includes a sheet of paint impervious masking material and a layer of adhesive. The layer of adhesive is disposed upon at least a portion of a side of the sheet of masking material. A pattern of perforations is defined through the sheet of masking material. A cut passes through the sheet of masking material and intersects the pattern of perforations.

According to another aspect of the invention, a method is provided for masking a motor vehicle which is to be painted. The method includes the steps of: providing a masking article comprising a sheet of a paint impervious masking material having a layer of an adhesive disposed upon at least a portion of a side thereof, a pattern of perforations defined therethrough so that selected portions of the sheet of masking material can be separated from the remainder of the sheet of material, and further having a cut which passes through the sheet of masking material and which intersects the pattern of perforations; detaching a portion of the sheet of masking material from the remainder of the sheet of masking material by tearing the sheet along the perforations commencing at the cut; and affixing the portion of the masking material to a vehicle.

According to another aspect of the invention, the method of masking the motor vehicle includes the steps of: providing the remainder of the sheet in the form of a roll; and separating the selected portion of the sheet from the roll along the pattern of perforations.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a top elevational view of a body of sheet material according to one embodiment of the invention;

FIG. 2 is a top elevational view of a body of sheet material according to a second embodiment of the invention; and

FIG. 3 is a perspective view of a roll of sheet material according to a third embodiment of the invention.

### DETAILED DESCRIPTION OF THE INVENTION

The present invention comprises a perforated sheet material having one or more specifically placed cuts which facilitate a clean tearing of the perforated material. In that regard, the invention is directed to a body of sheet material having a pattern of perforations defined therein which operate so as to permit a selected portion of the body of sheet material to be separated from the remainder of the body. In accord with the present invention, the sheet material is provided with at least one cut which passes through the thickness of the body of sheet material and commences at one edge of the body and intersects the pattern of perforations.

The principles of the present invention may be implemented in connection with variously configured perforated materials including roll materials such as paper toweling, bathroom tissue, wrapping paper and the like. The invention also has particular advantage when used in connection with specialty items such as pre-shaped masking materials, such as those masking materials utilized in connection with the painting of automobiles. Masking materials of this type are disclosed, for example, in published PCT Patent Application WO 03/070591, the disclosure of which is incorporated herein by reference.

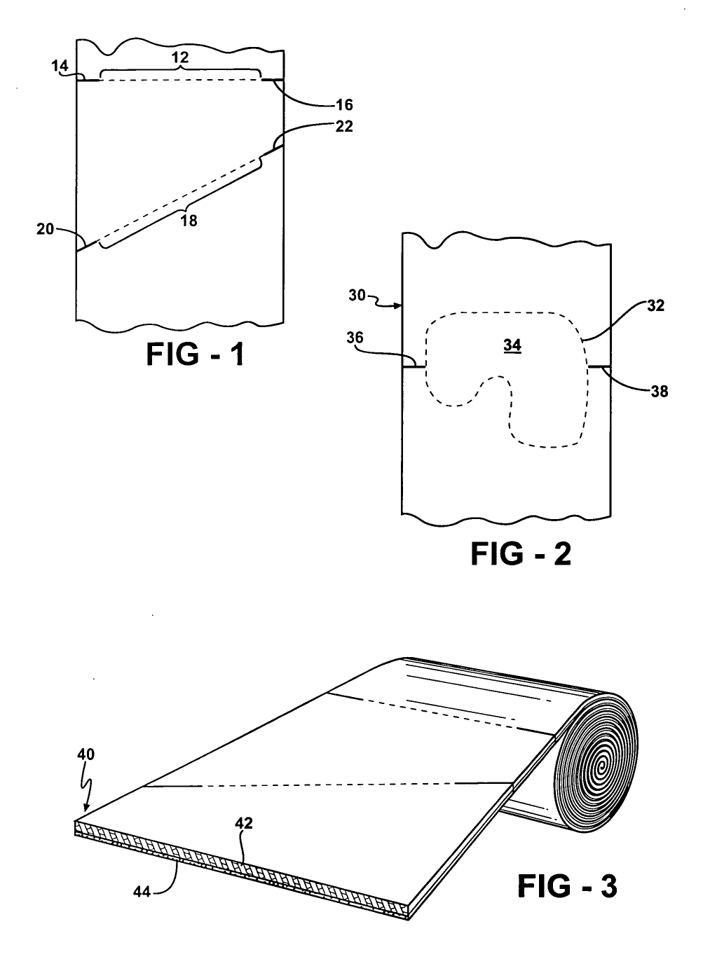

Referring now to FIG. 1, there is shown a body of sheet material 10 structured in accord with the principles of the present invention. The material 10 is meant to be representative of various types of sheet material, such as those referenced above. As illustrated, the sheet material 10 includes a pattern of perforations therein. One such pattern, which runs orthogonally with respect to a length of the sheet material 10, is shown at reference numeral 12. As is known in the art, such perforation patterns can be formed in the material by punching, cutting, or other processes. In accord with the present invention, the material 10 includes a first 14, and a second 16, cut therethrough. The cuts 14, 16 commence at a free edge of the material and extend to the perforated region 12. These cuts 14, 16 may be formed at the same time that the perforations 12 are formed, or they may be formed in a separate step. The cut is distinguished from a perforation insofar as the length of the cut is greater than the length of the average opening which defines the perforation. In particular instances the length of the cut is at least twice the length of the average perforation; while in other instances, the cut is at least three times the length of the average perforation.

In accord with the present invention, it has been found that the inclusion of a cut facilitates the clean tearing of the material along the perforated line 12. In addition, the presence of the cut allows for visual verification of the location of the perforated region. The presence of the cuts confers significant advantage to a user of the product insofar as tearing of the product is facilitated. It has, surprisingly, been found that inclusion of the cuts in materials used in a large-scale industrial application, particularly a production line application, results in very significant cost savings since the material of the present invention both minimizes the amount of spoiled material generated and greatly reduces lost time.

The principles of the present invention may be implemented in connection with variously configured and disposed patterns of perforations. As is also shown in FIG. 1, the body of material 10 includes a second set of perforations 18 which are disposed at an angle relative to the transverse dimension of the material 10. In this embodiment, cuts 20 and 22 are disposed so as to commence at a free edge of the material 10 and intersect the perforations 18.

Referring now to FIG. 2, there is shown another body of perforated material 30 structured in accord with the principles of the present invention. In the FIG. 2 embodiment, a pattern of perforations 32 is disposed and configured so as to bound and define an irregularly shaped region 34 within the perimeter of the body of material 30. Configurations of this type are frequently employed to prepare masking panels for use in painting of motor vehicles and the like. In accord with the present invention, a first 36 and a second 38 cut are disposed so as to commence at a free edge of the body of material 30 and run to the perforated pattern 32.

While in the foregoing figures, the sheet material is shown as including two cuts, in other instances, a single cut may be employed, while in yet other instances, a greater number of cuts may be employed. As noted above, the length of the cut is greater than the average length of the openings which define the pattern of perforations. Typically, the cut is at least twice, and in some instances at least three times, the length of the average opening in the pattern of perforations. Typically, the length of any one of the cuts is in the range of 1-20% of the length of the pattern of perforations, and in more specific instances, the length of any one of the cuts is in the range of 3-15% of the length of the pattern of perforations. In most instances, the length of the cut is in the range of 0.54.0 inches, and one specific range of length is 0.75-1.5 inches. If more than one cut is present, it is possible that the cuts may be of different lengths. However, each cut will generally fall within ranges of lengths set forth above.

The principles of the present invention may be employed in connection with any type of perforated sheet material including flat stock as well as rolled stock. Referring now to FIG. 3, there is shown one type of sheet material which can include the present invention. As specifically shown in FIG. 3, a body of sheet material 40 is configured as a masking material for use in the painting of motor vehicles. In that regard, the material 40 includes a topmost layer of masking material 42 which may comprise a paint impervious paper, a polymer, a metal foil, or any other such material or materials used singly or in combination. Also included in the material 40 is a layer of adhesive 44 which may cover all or part of the bottom side of the masking material 42. In other instances, further layers may be included. For example, a body of release material may be disposed atop the layer of adhesive 44. In such instance, the perforations and cuts may extend through the masking layer 42, the adhesive layer 44, and the release layer; or alternatively, the perforations and cuts may extend only through the masking layer, or through the masking and adhesive layers.

In view of the general principles described herein, yet other modifications and variations of the present invention will be readily apparent to one of skill in the art. The foregoing drawings, discussion and description are illustrative of specific embodiments, but are not meant to be limitations upon the practice thereof. It is the following claims, including all equivalents, which define the scope of the invention.

1. A body of sheet material having a pattern of perforations defined therein, said perforations being disposed and operational so as to permit a selected portion of said body of sheet material to be separated from a remainder of said body, wherein the improvement comprises:
at least one cut which passes through the thickness of said body of material, said at least one cut commencing at an edge of said body and intersecting said pattern of perforations.

2. The sheet material of claim 1, wherein said pattern of perforations is a linear pattern.

3. The sheet material of claim 2, wherein said pattern is orthogonal with respect to a length of said body of sheet material.

4. The sheet material of claim 2, wherein said pattern is diagonal with respect to a transverse dimension of said body of sheet material.

5. The sheet material of claim 1, wherein said pattern defines an irregular shape.

6. The sheet material of claim 1, wherein said body of sheet material comprises a paint masking material.

7. The sheet material of claim 1, wherein said body of sheet material includes a layer of an adhesive on one side thereof.

8. The sheet material of claim 7, wherein said body of sheet material is disposed upon a release layer and wherein said pattern of perforations and said at least one cut do not pass through said release layer.

9. The sheet material of claim 7, wherein said body of sheet material includes a release layer and wherein said pattern of perforations and said at least one cut pass through said body of release material.

10. The sheet material of claim 1, wherein at least one of said at least one cuts has a length which is in the range of 1-20% of the length of said pattern of perforations.

11. The sheet material of claim 10, wherein said length of at least one of said cuts is in the range of 3-15% of the length of said pattern of perforations.

12. The sheet material of claim 1, wherein the length of at least one of said at least one cuts is in the range of 0.5-4.0 inches.

13. The sheet material of claim 12, wherein the length of said one of said at least one cuts is in the range of 0.75-1.5 inches.

14. The sheet material of claim 1, wherein said body of sheet material comprises a body of a cellulose based material.

15. The sheet material of claim 1, wherein said remainder of said body of sheet material is provided in the form of a roll, said selected portion of said body being separable from said roll along said perforations.

16. A material for masking an article which is to be painted, said material comprising:
a sheet of paint impervious masking material;
a layer of adhesive disposed upon at least a portion of a side of said sheet of masking material;
a pattern of perforations defined through said sheet of masking material; and
a cut which passes through said sheet of masking material and which intersects said pattern of perforations.

17. A method for masking a motor vehicle which is to be painted, said method comprising the steps of:
providing a masking article comprising a sheet of a paint impervious masking material having a layer of an adhesive disposed upon at least a portion of a side thereof, and further having a pattern of perforations defined therethrough so that selected portions of said sheet of masking material can be separated from a remainder of said sheet of material, said masking article further including a cut which passes through said sheet of masking material and which intersects said pattern of perforations;
detaching a portion of said sheet of masking material from the remainder of said sheet of masking material by tearing said sheet along said perforations commencing at said cut; and
affixing said portion of said masking material to a vehicle.

18. The method of claim 17 including the step of providing said masking article in the form of a roll.

19. The method of claim 18 including the step of separating said selected portion of said sheet from said roll along said pattern of perforations.

20. The sheet material of claim 17, wherein said pattern is orthogonal with respect to a length of said sheet of masking material.
